(19) United States
(12) Patent Application Publication
(10) Pub. No.: US 2007/0011940 A1
(43) Pub. Date: Jan. 18, 2007

(54) Intermittent insect trap

(75) Inventors: Wen-Pin Chen, Taipei (TW); Nai-Ying Jean, Taipei (TW)

Correspondence Address: TROXELL LAW OFFICE PLLC, SUITE 1404, 5205 LEESBURG PIKE, FALLS CHURCH, VA, 22041, US

(73) Assignee: Kai Chih Industrial Co., Ltd.

(21) Appl. No.: 11/315,375

(22) Filed: Dec. 23, 2005

(30) Foreign Application Priority Data
Jul. 15, 2005 (TW) 094124117

(51) Int. Cl. A01M 1/08; A01M 1/02

(52) U.S. Cl. 43/113; 43/107; 43/139

(57) ABSTRACT

An intermittent insect trap, working time of which proceeds by alternating periods, and embodies two primary operations including actuation of ultrasonic waves to excite an attractant and form a mist and formation of a backpressure airflow, thereby ensuring that concentration of the mist is not disturbed and thus reduced by external forces during the course of vaporization, and thus preventing dilution of the attractant. Moreover, intermittent operation of a motor results in substantial savings in power. The insect trap primarily uses a mist excitation device to excite and disperse an insect attractant as attractant particles that suspend in the air and diffuse. After achieving a predetermined diffusion concentration, operation switches over to actuate a backpressure device, which pressures lured insects into a receiving chamber through a valve. The alternating working times and mechanical ensnaring of insects provide the insect trap with effective inducement and power saving features.

### BACKGROUND OF THE INVENTION

(a) Field of the Invention

The present invention relates to insect traps, and more particularly to an intermittent insect trap that provides two primary operations including quantification control of inducement and capture, which are divided into a preparation inducement period and actuation of a motor to form a backpressure trap stroke. The two operations alternate between start and stop to sufficiently distribute attractant particles that effectively attracts insects and interchanges with actuating the backpressure motor, thereby achieving a power saving and safe insect trap. Because of the power saving benefit of the insect trap, thus, small size batteries can be used, which facilitates use outdoors. Moreover, installation location of the insect trap is not limited by cables, thereby enabling it to be freely transported and placed on the ground, hung up, suspended, and so on, for use indoors and outdoors, in plant cultivation areas, and so on.

(b) Description of the Prior Art

The majority of conventional insect traps available for sale in the current market use ultraviolet light waves to attract insects towards the insect trap, whereupon the insects come in contact with a high voltage net, which causes a short circuit that strikes down the insects. Although such a method has a definite effect, however, the following shortcomings are still evident:

1. Wavelength of the ultraviolet light used is approximately 360 nanos, and such ultraviolet light waves are harmful to the retinas of a person that approaches within one meter of the insect trap. Moreover, a person is more prone to skin cancer after being exposed to the ultraviolet light for a long period of time.

2. There exists the danger of being electrocuted by the high voltage net used to trap insects, and a hazard to the limbs of children is particularly evident.

Regarding early insect trap devices that use ultraviolet light as an inducing medium, after insects are exposed to the ultraviolet light, a fan is used to pressure the insects towards the net, where they become entrapped. However, such a configuration enables the insects to escape after the fan activity stops, thereby causing continued needless wastage of electric power.

In recent years, other insect trap devices have appeared that use specific light waves of a light catalyst to act on an inducing medium and effectuate carbonization, wherein the operating process includes use of high voltage to shock the insects and a fan to whisk the insects towards the trap.

Furthermore, other insect traps use a light source to draw insects close to an insect trap, whereupon an electrified net shocks the insects and a fan concentrates the stream of insects to form a high speed stream of captured insects. However, such insect trap devices are extremely noisy.

Furthermore, other insect traps use a light source disposed in a box, which is used to lure the insects, whereupon an adhesive agent is used to adhere and entrap the insects, thereby forming a quiet functional operation. However, functional efficiency is poor.

U.S. Pat. No. 5,813,166 discloses an insect trap that uses natural vaporization of an attractant and a motor driven fan under continuous operation to ensnare as many insects as possible that approach the insect trap.

Because of the large current demand under normal operation of the aforementioned various insect trap devices, thus, a power supply must be provided. Hence, the corresponding power consumption foregoes the ability to use the insect traps outdoors. Moreover, there is no control over the actual time the attractant is dispersed. Furthermore, because the attractant is dispersed through natural vaporization using the Brownian movement effect of an ionized substance in air, thus, dispersal quantity cannot be appropriately controlled. The attractant is also affected by the continuously motor driven fan, and odor particles undergo mixed-flow dilution. Moreover, because of a backpressure (vacuum) space caused by the fan, thus, the attractant must be installed in a prescribed position. After the attractant has been vaporized, the fan draws it towards the direction of an arresting net, and thus the amount of vaporized attractant never reaches a satisfying required density. Hence, the attractant loses its inducement effectiveness.

### SUMMARY OF THE INVENTION

Primary object of the present invention is to provide an insect trap device that uses ultrasonic waves to excite an attractant and form a mist, the device functioning in coordination with an airflow backpressure device to actuate intermittent and staggered operation of working times and effectuate mechanical ensnaring of insects. Moreover, the insect trap device provides power saving features and safety in use.

Another object of the present invention is to configure a body temperature simulator device at a position adjoining an attracting area, thereby increasing effectiveness of luring insects close to the insect trap device.

A third object of the present invention is to configure a light generator having ultraviolet light emitting diodes at a position adjoining the attracting area, wherein the ultraviolet light emitting diodes emit inducing light. The light waves are directional and wavelength specific controlled to safeguard the eyes of any persons close to the insect trap device. Moreover, the light waves can be pulsed to enhance effectiveness of visual attracting insects.

A fourth object of the present invention is to provide the insect trap device with a mist excitation device comprising a piezoelectric ceramic driver that actuates a percussion board. A percussion hole is defined in the percussion board, and high frequency vibration of the percussion board is used to excite a water film formed at an end opening of a water guide fiber.

A fifth object of the present invention is to provide the mist excitation device with a floating member to support the piezoelectric ceramic driver, the percussion board extending from one side thereof. The percussion board is joined to the piezoelectric ceramic driver and forms a cantilever connection thereto. The percussion hole defined in the percussion board is made to come in contact with a liquid surface of a large quantity of liquid state attractant, a specific amount of which can be excited in a definite direction.

To enable a further understanding of said objectives and the technological methods of the invention herein, brief description of the drawings is provided below followed by detailed description of the preferred embodiments.

### BRIEF DESCRIPTION OF THE DRAWINGS

FIG. 1 shows an exterior view depicting structure of the present invention.

FIG. 2 shows a linear view depicting working time lines of a percussion board and a backpressure device according to the present invention.

FIG. 3 shows a structural view depicting primary component members of a mist excitation device according to the present invention.

FIG. 4 shows a schematic view depicting percussion slots defined in the percussion board according to the present invention.

FIG. 5 shows a schematic view depicting other percussion slots defined in the percussion board according to the present invention.

FIG. 6 shows a schematic view depicting FIG. 3 in use according to the present invention.

FIG. 7 shows a schematic elevational view depicting the percussion board joined to a rectangular driver according to the present invention.

FIG. 8 shows a schematic elevational view depicting the percussion board joined to a circular driver according to the present invention.

FIG. 9 shows a cross-sectional view of another embodiment of the mist excitation device according to the present invention.

FIG. 10 shows a schematic view of FIG. 9 using an oblique percussion board according to the present invention.

FIG. 11 shows another schematic view of FIG. 9 using an oblique percussion board according to the present invention.

FIG. 12 shows a schematic view depicting primary structure of a body temperature simulator device according to the present invention.

FIG. 13 shows a schematic view depicting primary structure of a light generator according to the present invention.

FIG. 14 shows a schematic view depicting assembly and working of the backpressure device and corresponding receiving chamber according to the present invention.

FIG. 15 shows a schematic view depicting working of a unidirectional valve and the corresponding receiving chamber according to the present invention.

FIG. 16 shows a control circuit diagram according to the present invention.

FIG. 17 shows a basic circuit diagram depicting temperature control according to the present invention.

FIG. 18 shows a graph depicting curves obtained when testing the body temperature simulator device according to the present invention.

### DETAILED DESCRIPTION OF THE PREFERRED EMBODIMENTS

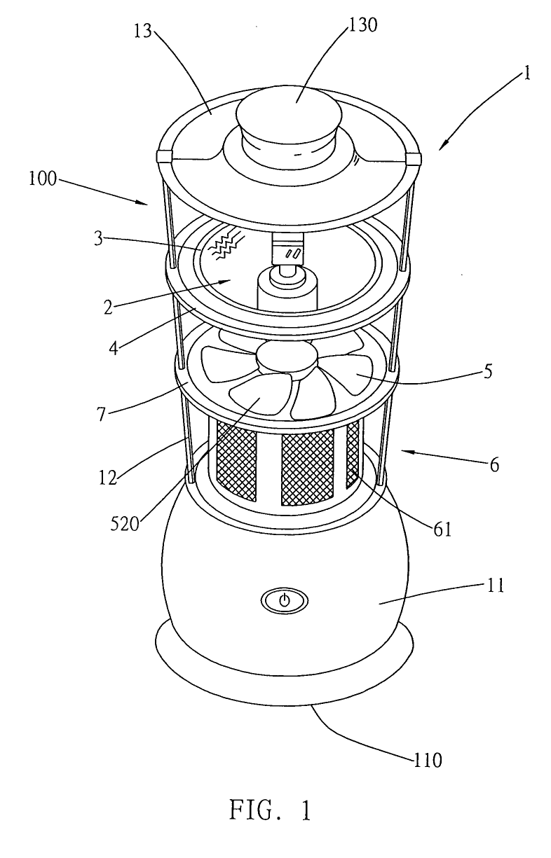

Referring to FIG. 1, which shows an intermittent insect trap of the present invention, wherein an insect trap 1 is primarily structured to comprise a base 11, a one-way successively arranged receiving camber 6 and a backpressure device 5, and a mist excitation device 2 disposed in an attracting area 100.

The mist excitation device 2 functions within the attracting area 100. A body temperature simulator device 3 and an ultraviolet light generator 4 are further disposed at corresponding positions in the attracting area 100. The light generator 4 further uses any intermittent operation circuit to control the light pulse and achieve a flickering action that generates a vivid stimulated light, which visually stimulates and attracts insects.

A stand 110 is formed at a bottom end of the base 11 to facilitate placing on the ground, thereby enabling the trapping of crawling insects, as well as flying insects, and so on. Moreover, a suspend member 130 is configured on an upper portion of a cover 13, which provides for hanging at a high position, or any hardware member can be used to assist in hanging the present invention to a wall.

The mist excitation device 2 produces an odor that attracts insects by dispersing to a periphery of the attracting area 100. After insects are lured into the attracting area 100, operation switches over to a period that actuates the backpressure device 5, which produces a backpressure airflow that pressures the insects into a receiving chamber 6.

Pressure release openings 61 are defined in the receiving chamber 6 to discharge airflow pressure, thereby creating an unhindered airflow path.

The aforementioned devices are assembled together by means of a frame 12. A mechanical unidirectional valve 7 is configured between the backpressure device 5 and the receiving chamber 6, and a pressure effect from the backpressure device 5 opens the unidirectional valve 7, thereby creating an airflow path to the receiving chamber 6.

The aforementioned body temperature simulator device 3 and the ultraviolet light generator 4 can function independently or in synchronization with the excitation device 2.

The present invention is covered with the dustproof cover 13.

Reflecting surfaces 520 are configured on surfaces of a fan 52 so as to face a light source. The reflecting surfaces 520 are curved reflecting surfaces because of the curved shape of the surfaces of the fan 52. Speed of rotation of the motor driven fan 52 slows down after a motor is turned-off, whereupon the curved reflecting surfaces 520 amplify reflection range of the light source at a specific point when angle is such that the insects are visually attracted. The reflected light presents a vivid flickering light to the insects, which together with the phototaxis of insects adds to increasing the attractant effectiveness.

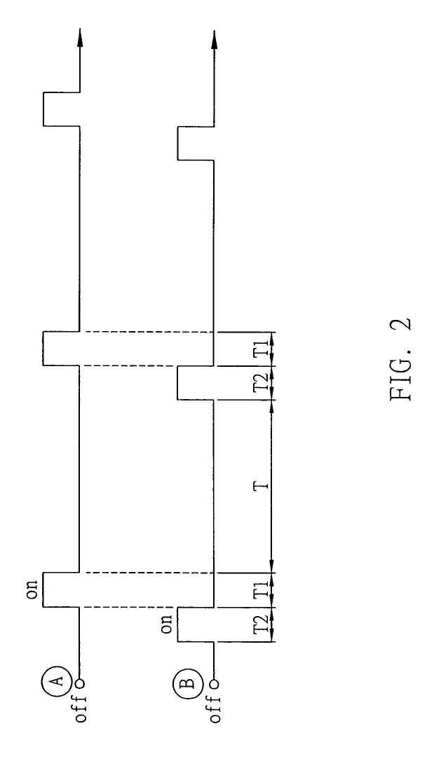

Referring to FIG. 2, which shows a linear view of the working time line A of the aforementioned mist excitation device 2 and a working time line B of the backpressure device 5.

An intermittent time T (preparation period) proceeds after T1 of the working time line A, whereafter working time period T2 of B is actuated, which after completion is continued with the next working time period T1 of A, thereby achieving intermittence and alternation, which enable the mist excitation device 2 and the backpressure device 5 to form an intermittent and alternating actuating operation.

Because the intermittent time T forms a waiting ensnare period, thus, needless waste of the attractant is avoided, and, moreover, saves on unnecessary current consumption. The alternating actuating operation is realized between the mist excitation device 2 and the backpressure device 5 by the working time of the mist excitation device 2 being arranged to occur immediately after completion of the backpressure device 5 working time, thereby enabling the insect trap 1 to form a practical ensnare operation sequence.

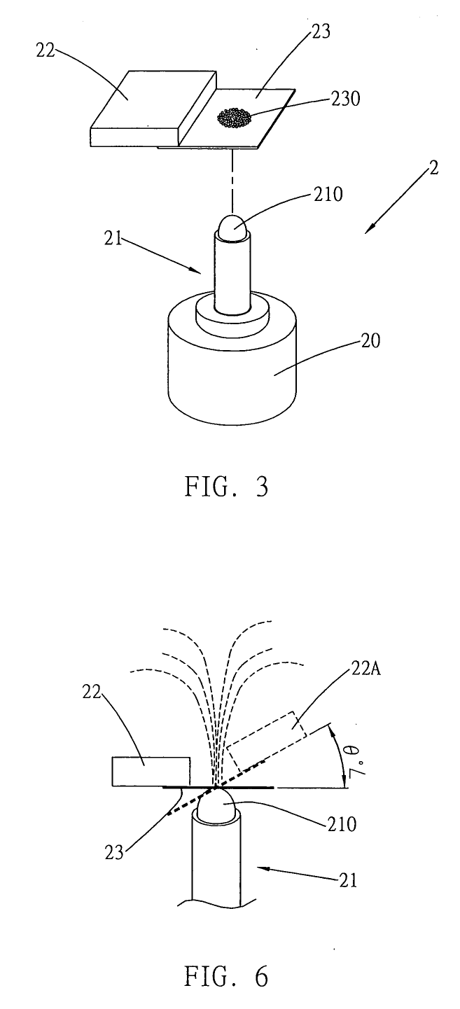

Referring to FIG. 3, the present invention specifically uses the low dissipation ultrasonic mist excitation device 2 to atomize the attractant and form minute particles therefrom, which then float in suspension in the attracting area 100.

It is known that when the particle diameter of a substance is diminished, diffusion theory tells us that rate of diffusion and diffusion distance of the particles are correspondingly increased. Hence, by the same principle, dispersal effectiveness of the attractant is substantially increased, which enables insects to be more easily attracted towards the insect trap 1.

The attractant can imitate the amine chemical substances present on the human body, for instance, the odor from normal excreted perspiration, to achieve effectiveness of inducing insects.

The mist excitation device 2 comprises a container 20, interior of which retains the attractant in liquid state that is used to induce insects. A water guide fiber 21 adsorbs the aforementioned attractant to an end opening 210 of the water guide fiber 21, whereat a water film is formed. A low voltage high frequency piezoelectric ceramic driver 22 actuates a percussion board 23, causing it to vibrate at high frequency.

A percussion hole 230 is defined in a surface of the percussion board 23, and the percussion hole 230 acts on the water film formed at the end opening 210 of the water guide fiber 21 to realize a continuous effect thereon.

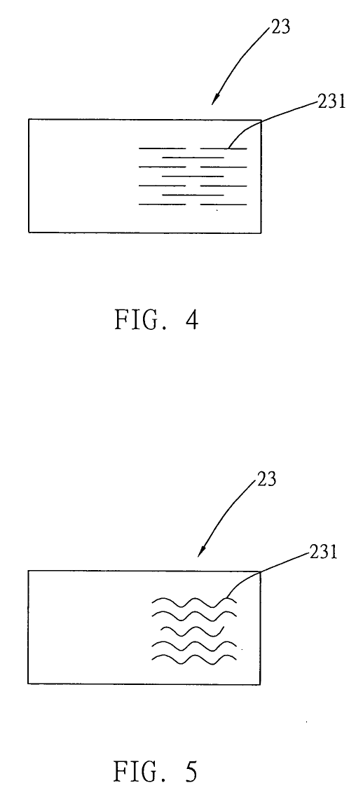

The aforementioned percussion hole 230 is a microhole, and if a minute granular dust particle enters therein, then there is the possibility of obstruction. Hence, the percussion hole 230 of the percussion board 23 can be formed as line-shaped percussion slots 231 (see FIG. 4), a plurality of which are juxtapositioned on the percussion board 23 with the condition that they do not affect the mechanical strength of the percussion board 23. Hence, if a granular particle enters one of the percussion slots 231 when in use, then the other percussion slots 231 enable operation to continue.

Referring to FIG. 5, if the distributed quantity of the percussion slots 231 on a definite area of a surface of the percussion board 23 is increased, and the percussion slots 231 are defined as curved line shapes, which are restricted to a prescribed breadth and length, then the line-shaped percussion slots 231 can be lengthened, thereby attaining a relatively larger work capacity, while still ensuring that work efficiency operates in coordination with the power supply.

Referring to FIG. 6, after the percussion board 23 has been actuated by the driver 22, the high frequency vibration produced by the vibrating percussion board 23 excites the water film drawn to the end opening 210 by the water guide fiber 21, thereby forming a mist.

Furthermore, the end opening 210 is an arc-shaped end opening, which is used to enable the percussion board 23 to press close thereto, and a θ° angle that the percussion board 23 makes with the end opening 210 can be altered within a permitted range, thereby correspondingly changing angle of the driver 22A to facilitate modulation of direction and amount of mist sprayed.

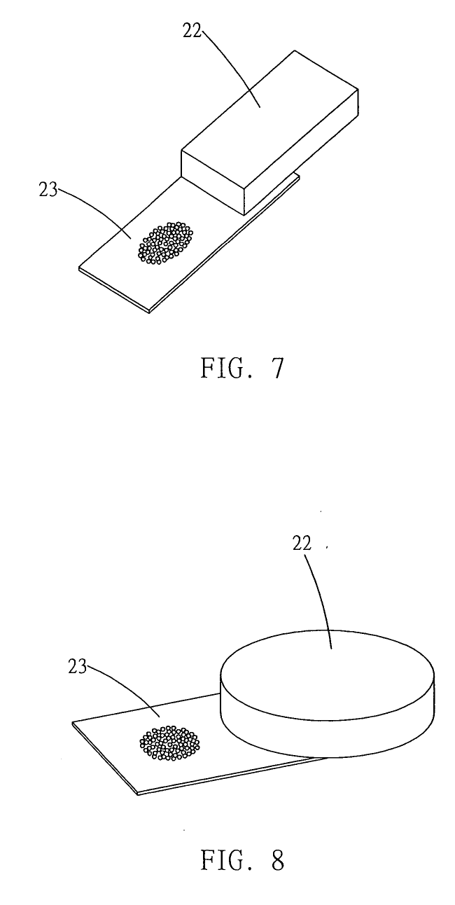

Referring to FIG. 7, which shows the driver 22 as a rectangular form, the percussion board 23 extending from one side thereof. The percussion board 23 is joined to the driver 22 and forms a cantilever connection thereto.

Referring to FIG. 8, which shows the driver 22 further designed as a circular form, which drives the percussion board 23. The circular form driver 22 is eccentrically joined to the cantilever percussion board 23 extending sideward therefrom.

Material used to fabricate each type of the aforementioned percussion boards 23 can be laminar metal or a plastic membrane, thickness of which is approximately 15˜50 mm, and the percussion hole is defined in the surface thereof.

Furthermore, any agglutination or soldering method can be adopted to join the percussion board 23 to the piezoelectric ceramic driver 22.

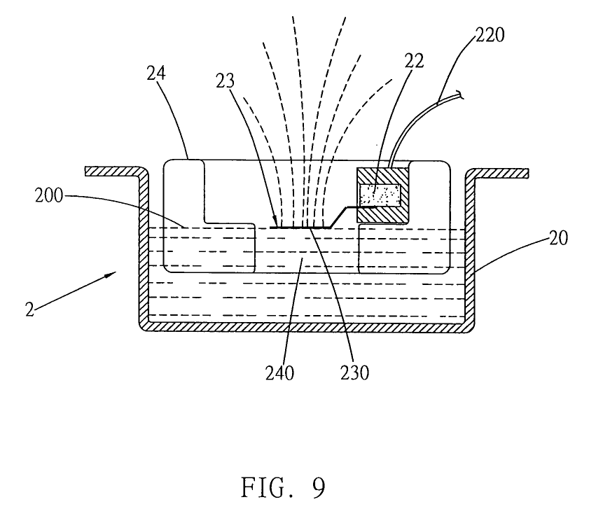

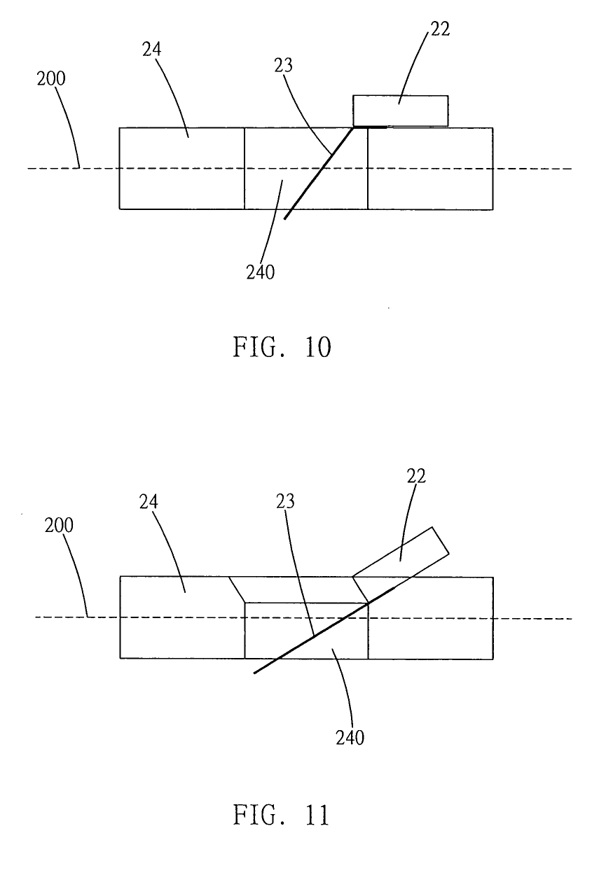

Referring to FIG. 9, which shows the mist excitation device 2 adopting a floating configuration whereby a floating member 24 floats within the open form container 20 filled with the liquid state attractant. The floating member 24 floats on top of a liquid surface 200, and a through hole 240 is formed central of the floating member 24, which provides for the percussion board 23 to be positioned therein.

The floating member 24 bears the weight of the driver 22, which is joined to the percussion board 23, and the driver 22 is connected to a power supply through an electric cable 220. Surface contact between the percussion board 23 and the liquid surface 200 is used to excite the liquid state attractant, thereby generating a large quantity of mist.

Any method can be used to integrate the container 20 to a position adjoining the attracting area 100 (see FIG. 1).

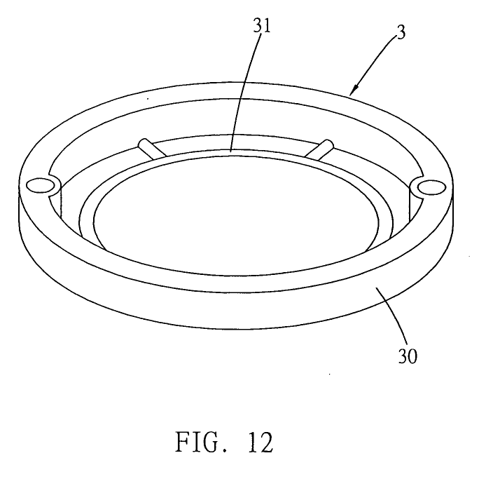

Referring to FIG. 10, which shows the floating member 24 floating on the liquid surface 200 and the percussion board 23 arranged in the central through hole 240. The percussion board 23 is joined obliquely to the driver 22, thereby enabling the percussion board 23 to enter the liquid surface 200 at an angle, which facilitates disposing the driver 22 on a surface of the floating member 24.

Referring to FIG. 11, which shows the floating member 24 floating on the liquid surface 200, and the percussion board 23 arranged in the central through hole 240. The percussion board 23 is joined linearly to the driver 22, and the driver 22 together with the percussion board 23 are joined to the floating member 24 at the same angle.

Referring to FIG. 12, the aforementioned body temperature simulator device 3 is joined to the attracting area 100 using a joining member 40 (see FIG. 1), and a heating element 31 is connected to a bottom portion of a frame 30.

Temperature produced by the heating element 31 is between 38° C. and 42° C. which exceeds temperature range of the human body and provides an offset to the ambient air temperature, and enables furnishing the attracting area 100 with a residual temperature close to body temperature.

The heating element 31 can be any thermal resistor element or positive temperature coefficient ceramic resistor. A self constant temperature property of the heating element 31 is used to realize the required temperature curve.

A circuit can be used to control the temperature produced by the heating element 31 or any heat dissipating element can be used to dissipate the heat or any art can be employed that causes value of the terminal temperature to be within the required temperature range.

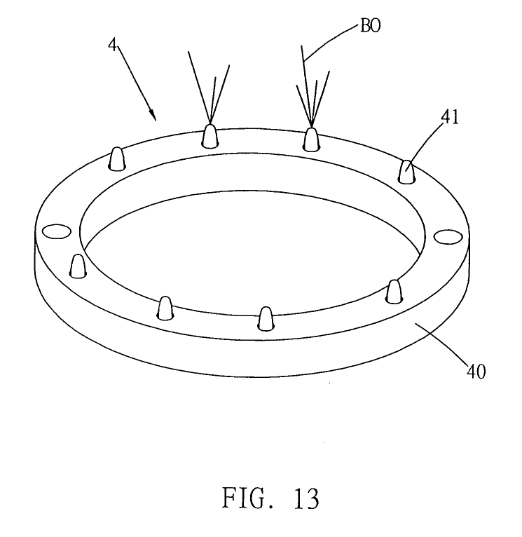

Referring to FIG. 13, which shows the ultraviolet light generator 4 joined to the joining member 40. Any method can be used to adjoin the joining member 40 to the attracting area 100 (see FIG. 1).

Ultraviolet light emitting diodes 41 are configured on the joining member 40 so as to face the attracting area 100, and ultraviolet light beams B0 emitted by the ultraviolet light emitting diodes 41 provide sufficiently focused light beams or scattered light beams that attract insects. Moreover, the ultraviolet light beams B0 are guided to within the attracting area 100, where they are reflected to prevent needless escape of the ultraviolet light beams B0, which could otherwise cause harm to the eyes. Wavelength of the ultraviolet light beams B0 is controlled so as to produce a specific safe frequency.

Preferred wavelength of the aforementioned ultraviolet light beams B0 is between 360 and 420 nanos.

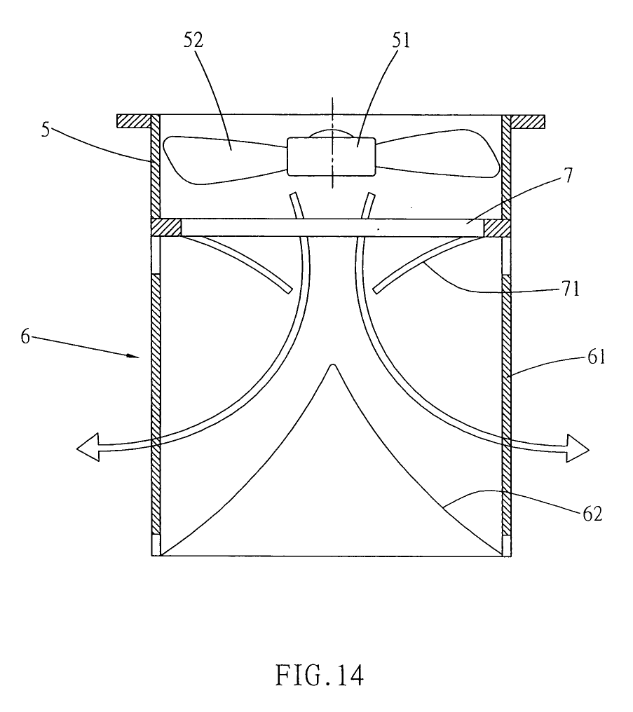

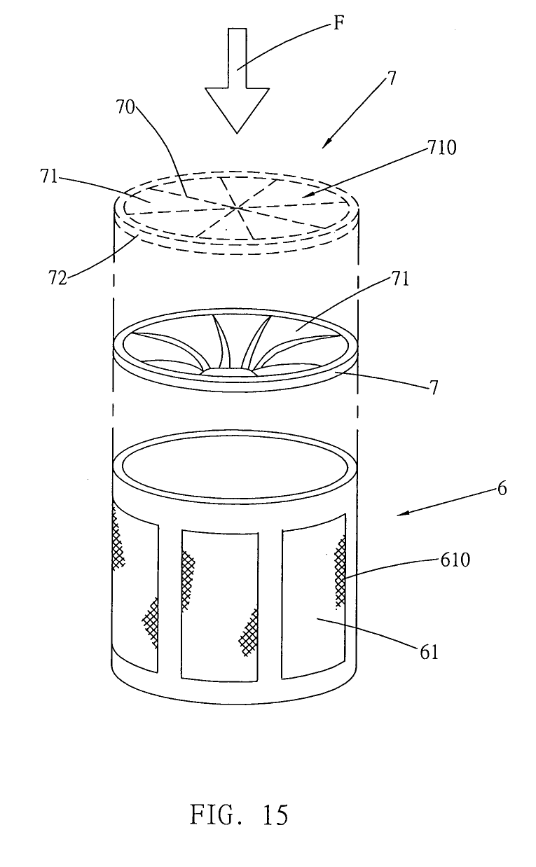

Referring to FIG. 14, which shows the backpressure device 5 driving the fan 52 by means of a motor 51. An axial flow method connects the airflow from the fan 52 to the receiving chamber 6, in the path of which is disposed the unidirectional valve 7. The pressure release holes 61 are defined in the receiving chamber 6.

The air flow pressured into the receiving chamber 6 by the backpressure device 5 first pushes down on valve gates 71 of the unidirectional value 7, thereby opening the valves gates 71 and forming a passageway for air to flow into the receiving chamber 6. The pressure release holes 61 defined in the receiving chamber 6 release positive pressure out of the receiving chamber 6.

A bottom portion of the receiving chamber 6 is further configured with a deflector cone 62, presence of which can prevent a mixed flow from occurring in the air entering the receiving chamber 6, which would otherwise dissipate kinetic energy of the airflow.

Referring to FIG. 15, the unidirectional valve 7 can be any mechanical opening and closing unidirectional valve driven by electromagnetic force, a motor, and so on, which works in synchronization with a fan motor configured on the backpressure device 5 or the unidirectional valve 7 can be fabricated from mechanical automatic repositioning valve gates or simply constructed from a macromolecular diaphragm 710 peripherally structured with a securing rim 72. Groovings 70 radially equally segment the macromolecular diaphragm 710 to form a plurality of independent valve gates 71.

The valve gates 71 are subjected to approximately one gram of air pressure, which enables the unidirectional valve 7 to downwardly open. After a wind force F from the fan 52 stops, a resilient restoring effect of the unidirectional valve 7 causes the valve gates 71 to reposition and form a closed state.

The pressure release holes 61 defined in the receiving chamber 6 are blocked with nets 610, thereby preventing insects ensnared within the receiving chamber 6 from escaping, and forming a mechanical snare.

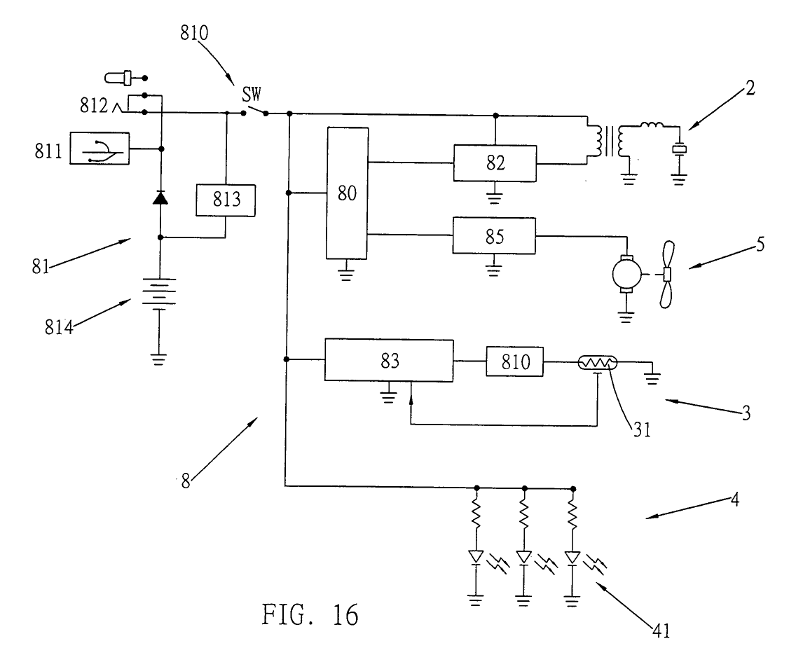

Referring to FIG. 16, which shows a control circuit 8 that controls working times of the aforementioned devices. A power source device 81 configured in the control circuit 8 acquires electric power through a guide terminal 812. The guide terminal 812 can also use a USB (Universal Serial Bus) terminal 811, which enables connecting to a computer to supply electric power to actuate the power source device 81. A charge return circuit 813 used to charge a battery 814 is configured on one side of the power source device 81. After the battery 814 has become discharged, switching on a switch 810 enables the input of electric power required by the control circuit 8. Because of the low working voltage requirements of the entire insect trap 1, thus, the battery 814 used can be a small size battery, thereby facilitating use of the insect trap 1 at any location indoors or outdoors. Moreover, the insect trap 1 is portable, can be placed on the ground, and facilitates installation in any formal space.

The electric power is supplied to a time control device 80, which controls a ultrasonic drive circuit 82 and a fan drive circuit 85, which realize alternating varied time modulation control of the excitation device 2 and the backpressure device 5. Modulation states are as depicted in FIG. 2.

A heat control device 83 controls the opening and closing operation of the power source 810 that supplies power required by the heating element 31 of the body temperature simulator device 3.

The body temperature simulator device 3, with an application concept as depicted in FIG. 12, uses the heat control device 83 to control the working tine required by the heating element 31. If the heating element 31 is a positive temperature coefficient ceramic resistor, then functional coordination of such a heat dissipating structure can simplify the heat control device 83.

Furthermore, in order for the heating element 31 to function in coordination with the power source and work under low voltage conditions, after an electric current is supplied to the switch 810, the ultraviolet light generator 4 is unilaterally actuated and drives the light emitting diodes 41 to produce ultraviolet light waves.

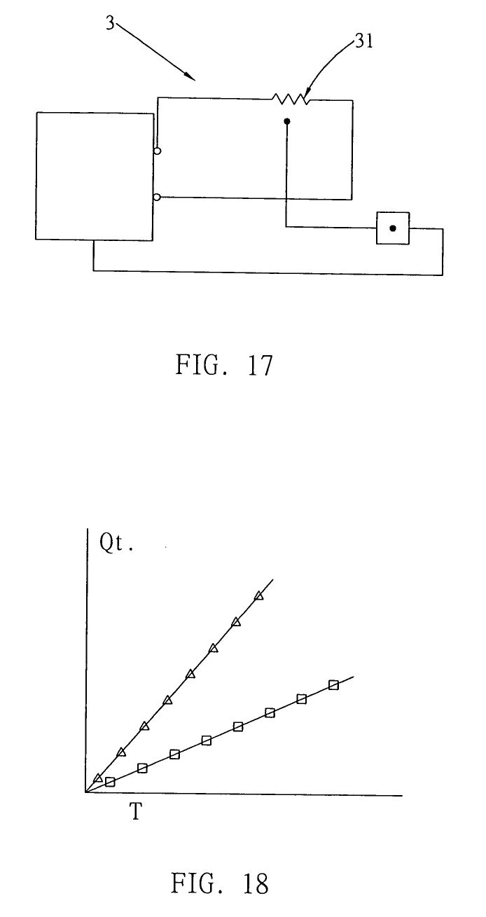

Referring to FIG. 17, a CV, CP and CT type circuit is used in order for the heating element 31 to function at a relatively high efficiency, wherein the circuit functions under conditions of constant voltage (CV), constant power (CP) and constant temperature (CT), thereby attaining the most stable heating effect.

Heating temperature is controlled between 38° C. and 42° C., and FIG. 18 depicts the graph obtained after heat is added to the body temperature simulator device 3, wherein the squares plot a curve with the heat source not actuated, and the triangles plot a curve with heating actuated. The graph obtained from the test experiment clearly shows an increase of approximately 40% in ensnaring capability.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. An intermittent insect trap, comprising a base, on top of which is configured an attracting area, a mist excitation device is configured at a position adjoining the attracting area, and the intermittent insect trap is further configured with a backpressure generator device; wherein the backpressure generator device and a mist excitation device control an alternating intermittent operation by way of a control circuit.

2. The intermittent insect trap according to claim 1, wherein an attractant excitation device comprises a piezoelectric ceramic driver that drives a percussion board; a percussion hole is defined in a surface of the percussion board, and the percussion hole acts on an end opening of a water guide fiber; one end of the water guide fiber is disposed within a container filled with an attractant.

3. The intermittent insect trap according to claim 2, wherein the end opening of the water guide fiber is arc-shaped.

4. The intermittent insect trap according to claim 2, wherein the percussion hole defined in the percussion board can be further defined as penetrating line-shaped percussion slots.

5. The intermittent insect trap according to claim 4, wherein the line-shaped percussion slots are curved line slots.

6. The intermittent insect trap according to claim 1, wherein a body temperature simulator device is further configured in the attracting area.

7. The intermittent insect trap according to claim 6, wherein the body temperature simulator device uses a positive temperature coefficient ceramic resistor having a constant temperature effect as a heating element.

8. The intermittent insect trap according to claim 1, wherein a light generator having ultraviolet light emitting diodes that emit light having a wavelength between 360 and 420 nanos able to attract insects, is configured at a position adjoining the attracting area.

9. The intermittent insect trap according to claim 1, wherein the attractant excitation device is a floating member that floats on a liquid surface of the attractant filled within an open form container; the floating member supports the piezoelectric ceramic driver that is joined to the percussion board, and the percussion hole defined in the percussion board acts on the liquid.

10. The intermittent insect trap according to claim 9, wherein the percussion hole defined in the percussion board can be further defined as penetrating line-shaped percussion slots.

11. The intermittent insect trap according to claim 10, wherein the line-shaped percussion slots are curved line slots.

12. The intermittent insect trap according to claim 1, wherein a control circuit is disposed within the base.

13. The intermittent insect trap according to claim 1, wherein batteries are used as a power source for the control circuit, the backpressure generator device or the attractant excitation device.

14. The intermittent insect trap according to claim 12, wherein batteries are used as a power source for the control circuit, the backpressure generator device or the attractant excitation device.

15. The intermittent insect trap according to claim 1, wherein a USB connection is used to supply power to the control circuit, the backpressure generator device or the attractant excitation device.

16. The intermittent insect trap according to claim 12, wherein a USB connection is used to supply power to the control circuit, the backpressure generator device or the attractant excitation device.

17. The intermittent insect trap according to claim 1, wherein a lower portion of the base is further configured with a receiving camber that is able to discharge airflow and release pressure, and an interlinking path is formed between the receiving chamber and the backpressure generator device.

18. The intermittent insect trap according to claim 17, wherein the path is fitted with a unidirectional valve.

19. The intermittent insect trap according to claim 18, wherein the unidirectional valve is a macromolecular diaphragm, a periphery of which is secured with a securing rim; radiating groovings equally segment the macromolecular diaphragm to form a plurality of valve gates.

20. The intermittent insect trap according to claim 18, wherein the unidirectional valve is controlled by electromagnetism or an electromechanical motor or is any mechanical-type valve, and operates in synchronization with the backpressure generator device.

21. The intermittent insect trap according to claim 17, wherein a deflector cone is fitted within the receiving chamber.

22. The intermittent insect trap according to claim 1, wherein the backpressure generator device is configured for a motor to drive a fan.
